(19) United States
(12) Patent Application Publication
(10) Pub. No.: US 2024/0100582 A1
(43) Pub. Date: Mar. 28, 2024

(54) METHOD AND SYSTEM FOR FORMING TUBULAR OR TRUNCATED CONICAL SEGMENTS

(71) Applicant: Sif Holding N.V., Roermond (NL)

(72) Inventor: Michel Antoin Marie KURSTJENS, Beesel (NL)

(73) Assignee: Sif Holding N.V., Roermond (NL)

(21) Appl. No.: 18/273,197

(22) PCT Filed: Jan. 18, 2022
(86) PCT No.: PCT/NL2022/050018

§ 371 Date: Jul. 19, 2023

(30) Foreign Application Priority Data
Jan. 20, 2021 (NL) 2027354

(51) Int. Cl. B21C 37/08

(52) U.S. Cl. CPC B21C 37/0803

(57) ABSTRACT

Method for forming tubular segments, wherein a metal strip is or a series of metal strips is pressed into a tubular or truncated conical shape, such that opposite longitudinal ends of the strip or strips meet, forming at least one seam, where after the seam is welded, joining the meeting ends together, wherein at least after welding the cross sectional profile of at least part of the segment is measured, at least at and/or near said welded seam or seams, and data of said measurement is fed into a control unit, where after a press is operated by the control unit based on said data, adjusting the cross sectional profile of the segment, at least at the or each seam.

The invention relates to a method for forming tubular segments. The invention further relates to a press system for forming tubular or truncated conical metal segments.

Tubular and truncated conical segments are known in the art and are used for example for forming generally large tanks, silos, towers for wind turbines and foundation piles, for example for on-shore or off-shore constructions such as wind generators.

Such tubular segments may be several meters in diameter, and are commonly formed by pressing a metal strip of up to several centimeters in thickness into such segment using a press, especially a roller press, or forming several segment portions and then connecting them together, thus forming such segment. The metal strip is or strips are pressed into a tubular or hollow truncated conical shape or portions thereof, such that opposite longitudinal ends of the strip or strips can meet, forming one or more seams. The or each seam is welded, joining the meeting ends together.

For different applications it may be highly desirable or even prescribed that the cross sectional profile of one end of the segment is, or of both opposite ends of the segment are within prescribed limits, for example within a predefined minimal and maximal radius. It is known that welding ends of segments together will almost inevitably influence the cross sectional profile of the segment, at least at and near the seam, deforming because of heating and cooling, addition of material and the like. This will bring at least part of the profile outside the set limits, for example too far inward or too far outward. After welding the cross sectional profile of at least part of the segment is therefore measured, at least at and/or near said welded seam, in order to assess the profile in view of the set limits. This allows the operator to again feed the segment into and/or through the press, in order to adjust the profile after welding, using the press.

In order to assess the cross section profile of the segment in the art a template is used, representing a part of a desired profile. The template is pushed against an outer surface or inner surface of the segment by an operator, where after the operator visually inspects any space between the template and the surface it is held against. Based on experience the operator then feeds the segment back into and/or through the press, trying to locate the part of the segment he has assessed in the press and then operate the press in order to readjust the profile of the segment in order to bring the relevant part of the profile within the set limits.

The known method is laborious and prone to mistakes. The operator may position the template incorrectly, may assess the differences between the template and the actual measures surface different from reality and may set and control the press incorrectly. Moreover the effectiveness of this method will depend largely on the experience of the operator.

An aim of the present disclosure is to provide for an alternative method for forming tubular or truncated conical segments. An aim of the present disclosure is to provide for such method providing better control of the forming process. An aim of the disclosure is to provide for a method for forming tubular or truncated conical segments which is more efficient and effective. An aim of the disclosure is to provide for a method for forming tubular or truncated conical segments, which can improve performance over time. An aim of the present disclosure is to provide for a press system for forming tubular or truncated conical segments, making such segments in an easier and better controlled manner.

At least one of these aims can at least in part be obtained with a method or press system according to the disclosure.

In an aspect a method according to the disclosure comprises steps for forming tubular segments, wherein a metal strip is or a series of metal strips is pressed into a tubular or truncated conical shape, such that opposite longitudinal ends of the strip or strips meet, forming at least one seam, where after the seam is welded, joining the meeting ends together. At least after welding the cross sectional profile of at least part of the segment is measured, at least at and/or near said welded seam or seams. Data of said measurement is fed into a control unit, where after a press is operated by the control unit based on said data, adjusting the cross sectional profile of the tubular segment, at least at the or each seam.

With a method according to the disclosure the control unit can accurately control and hence operate the press for amending the cross sectional profile at the proper position, to bring it closer to or within a desired profile. A method according to the disclosure will allow for easier and more accurately forming of segments having a desired configuration.

In an aspect of a method according to the disclosure the cross sectional profile of the segment is measured using a measurement tool, wherein the measurement data obtained with the measurement tool comprise at least location data of a relevant part of the profile measured relative to the tool and the distance between said part of the profile and the tool.

Such method allows for even more easy accurate positioning of the segment in the press for adjusting the profile at the accurate position or positions. For example the location of the measured part of the segment is defined relative to the press, such that with the press the relevant part of the segment can easily be brought into the press in a correct position, for example by rotating rolls of the press.

In embodiments of a method according to the disclosure the metal strip is rolled or set into a segment having, at least at one end of the segment, a circular or semicircular cross section for which a desired radius is set in the control unit between a set minimum radius and a set maximum radius, wherein after welding the actual radius is measured at least at the seam, which actual radius is compared to the set desired radius, where after the press is operated by the control unit for reducing any deviation between the actual radius and the desired radius.

In such embodiments segments are formed having a substantially circular cross section, which have to have at least at one end a substantially constant, desired radius, for example measured at an inside or an outside surface of the segment. Said desired radius has to be within set minimum and maximum limits, for example to fulfil legal or customer requirements and to be compatible with segments to be connected to it at said longitudinal end or ends. With embodiments of a method of the disclosure the press is operated by the control unit, bringing the actual radius between the set minimum radius and the set maximum radius.

In embodiments of the disclosure one or more roller presses are used. In embodiments at least two presses are used, one for prepressing or bringing the strip roughly into the desired tubular or truncated shape, and a second press for adjusting the cross sectional profile of the tubular segment after welding. The first and second press may be the same press but preferably the first press is a different press from the second press. For example the first press can be a four roll press and the second press can be a three roll press.

In an aspect a method according to the present disclosure can be characterized in that, at least for adjusting the cross sectional profile at the seam after welding, a roller press is used, having at least three rolls, wherein the segment is supported by two rolls at an outer surface of the segment, at opposite sides of the seam, and at least a third roll of said rolls is pushed against an inner surface of the segment, at or near the seam, towards the two rolls at the outer surface, wherein a force for said pushing and/or a distance of travel of the third roll relative to the two rolls at the outer surface is controlled by the control unit based on the measurement data.

By using at least three rolls the segment can be easily and accurately supported at the outer surface, whereas at least one further roll can be used for pressing down on the segment, seen radially between the said two supporting rolls, relative to said two rolls, wherein the measurement data can be used for accurate movement and/or force of the further roll. This will enable accurate adjustment of the relevant part or parts of the segment in order to bring the cross sectional profile within specification set for the profile. Obviously in embodiments also a press can be used in which a part of the cross sectional profile of the segment is pushed inward, i.e. towards a center line of the segment, if the deformation of the profile is directed outward.

In a method according to the disclosure a non-contact measurement tool can be used, such as for example an optical measurement system, for example a laser measurement system or a digital camera system, or a mechanical measurement system, such as for example a digital measurement clock or a dial gauge measurement system, or combinations of non-contact and contact measurement systems.

A method according to the present disclosure can be specifically directed to forming segments of a foundation pile or tower of for example a wind turbine or of an off-shore construction. More generally a method according to the disclosure can especially be used for forming relatively large diameter segments for elongated hollow constructions, for which narrow tolerances are applicable in cross sectional profile, such as for example tubular segments having a wall thickness of centimeters, for example between 1 and 10 cm, such as for example between 3 and 6 cm, a cross sectional diameter of several meters, for example more than 5 meters in diameter at the largest cross section, such as for example more than 6 meters, or more than 8 meters, and tolerances for the diameter of only a few millimeters, for example less than 10 mm, such as for example less than 7 mm, for example 4 mm or less.

In an aspect a press system according to the disclosure, for forming a tubular or truncated conical metal segment, can be characterized by comprising at least a press and a control unit for controlling the press, wherein the system further comprises a measurement tool for measuring at least part of a cross sectional profile of the tubular or truncated conical segment, which measurement tool is connected to the control unit for feeding measurement data into the control unit, and wherein the control unit comprises at least an algorithm for controlling the press, based on at least said measurement data.

The measurement tool provides measurement data electronically to the control unit, for example digital data, which can be used by the control unit of the press for controlling the press.

The measurement tool can in embodiments be a contact free measurement tool, such as an optical measurement tool. In embodiments the measurement tool comprises at least a laser measurement system.

In embodiments the press system, especially the control unit can comprise a memory comprising at least a predefined desired radius of a segment to be formed and wherein the control unit and measurement tool are designed for obtaining and processing measurement data including location data of locations at said segment and radius data at said locations, wherein the control unit further comprises an algorithm for comparing the radius at said location with the desired radius and controlling the press based on said comparison.

With such system for one, several or substantially all locations along the entire cross section of the segment a combination set of data can be stored, comprising data of the relevant location relative to for example the measurement tool or the press, and a distance between the measurement tool and the profile at said location, which can for example be a radius of the segment at said location, or can be translated into a radius.

For example, for segments which have to have a circular cross section, the desired radius will be the same for all locations, which can then be compared to the actual, measured radius at said location. Based on such comparison and location data the segment can then be moved in the press, such that the relevant location is brought into the press, i.e. between the rollers of a roller press or at the table of a bench press or the like, where after the press can be operated by the control unit for changing the radius at said location, bringing it closer to the set desired radius. If the cross section should not be circular but for example oval, elliptical or the like, obviously the desired radius for different locations will be different.

In embodiments a press system of the disclosure can comprise at least a first press for pre-pressing a segment, a welding station for welding at least one seam in said segment and a second press for re-pressing the formed segment after having undergone a welding process in said welding station. Preferably the first and second press are different presses, for example stationed near a beginning and near an end of a segment processing line, wherein the welding station may be located in between the two presses.

In embodiments the control unit comprises an algorithm for performing the steps of measuring the at least part of a cross sectional profile of a tubular or truncated conical segment and of controlling the press, based on at least said measurement data repetitively, during a pressing step of a segment. The control unit can further be designed for using the measurement data of pressing steps for assessment of the control of the press during a subsequent pressing step.

In such embodiments at least one part of the cross sectional profile of a segment can be adjusted in a series of two or more adjusting steps, with at least a measurement step in between the adjusting steps, such that the relevant radius at the location can be brought closer to the desired radius in consecutive steps.

The disclosure further relates to a computer program product comprising a computer readable program for control of a pressing process for forming tubular or truncated conical metal segments, wherein the program is designed for receiving measurement data pertaining to a cross sectional profile of at least part of such segment and controlling a press for adjusting said profile.

For a better understanding of the disclosure embodiments of a method, press system and computer program product according to the disclosure will hereafter be described, by way of example only, with reference to the drawings. Therein shows:

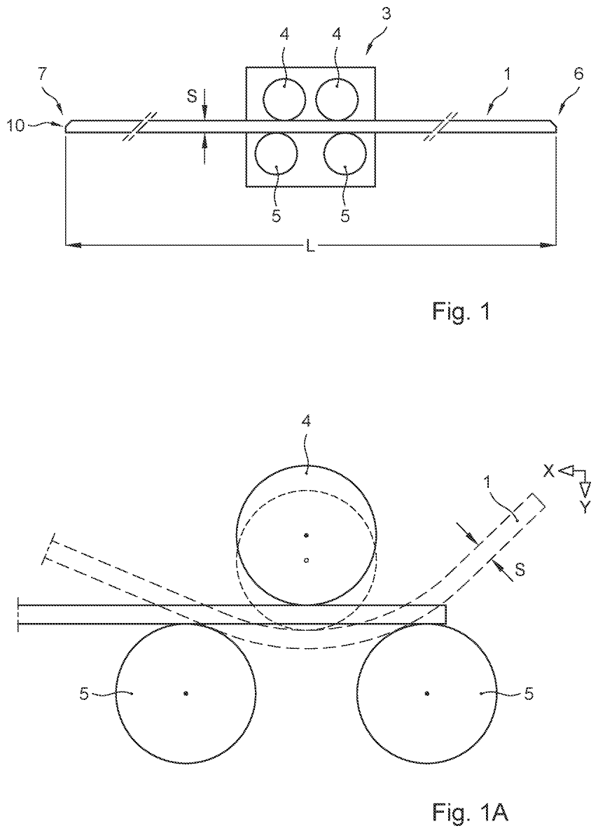

FIG. 1 in end view schematically a metal strip fed into a press;

FIG. 1A schematically a strip in a press, at feeding and during pressing;

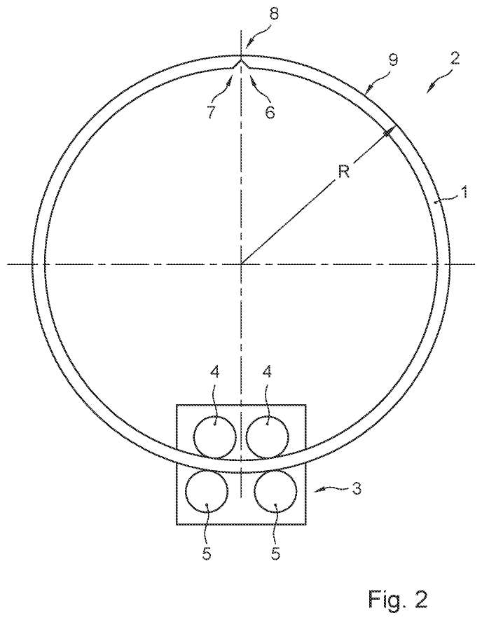

FIG. 2 in end view schematically the strip of FIG. 1, forced into a tubular segment, opposite ends of the strip meeting forming a seam, in the press;

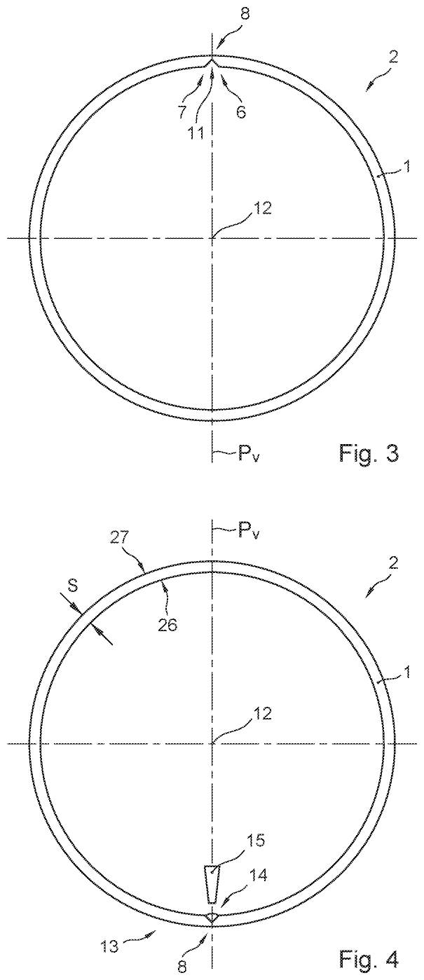

FIG. 3 in end view schematically a tubular segment, before welding of the seam;

FIG. 4 in end view schematically a tubular segment in a welding station;

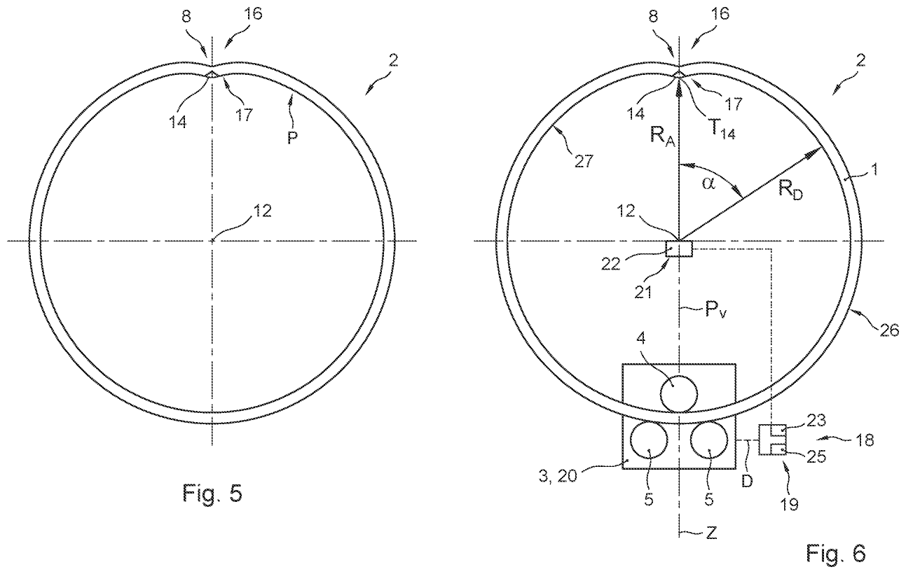

FIG. 5 in end view schematically a tubular segment after welding;

FIG. 6 in end view schematically a tubular segment after welding, in a press, during measurement of at least part of a cross sectional profile of the tubular segment;

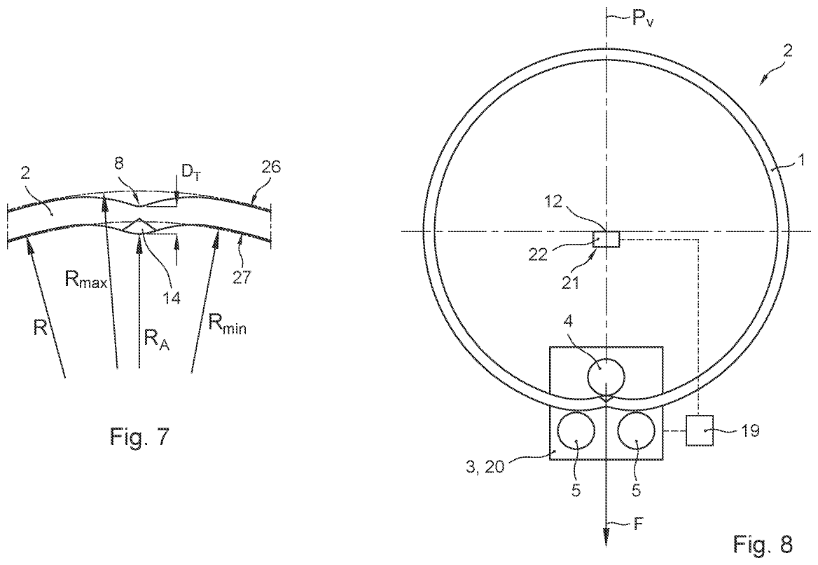

FIG. 7 in end view schematically part of a cross sectional profile, comprising a weld, showing deformation due to at least welding of the seam;

FIG. 8 in end view schematically a segment with a deformed party of the cross sectional profile in the press;

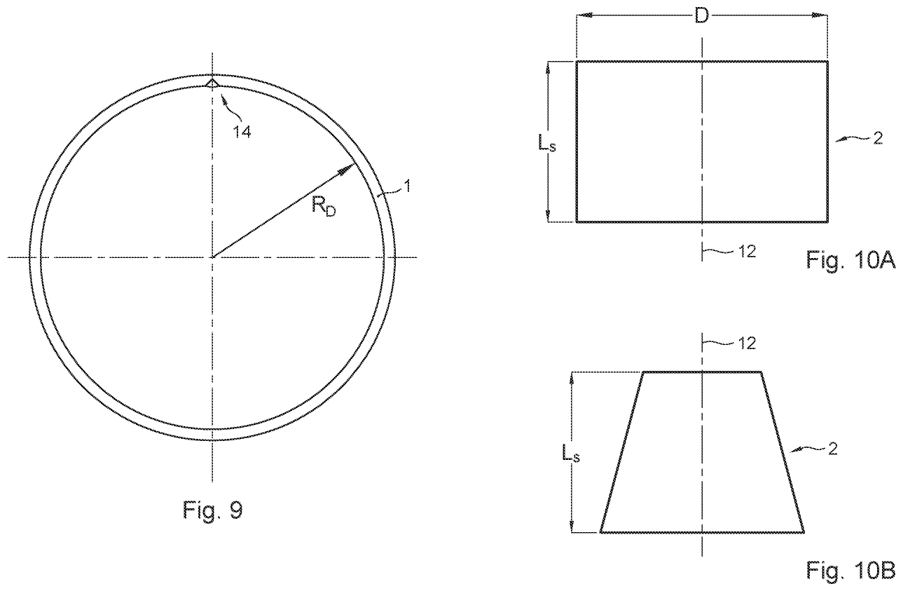

FIG. 9 in end view schematically a segment, especially a cross sectional profile after measurement and repressing;

FIGS. 10A and 10B schematically in side view a tubular segment and a truncated conical segment formed according to the disclosure; and

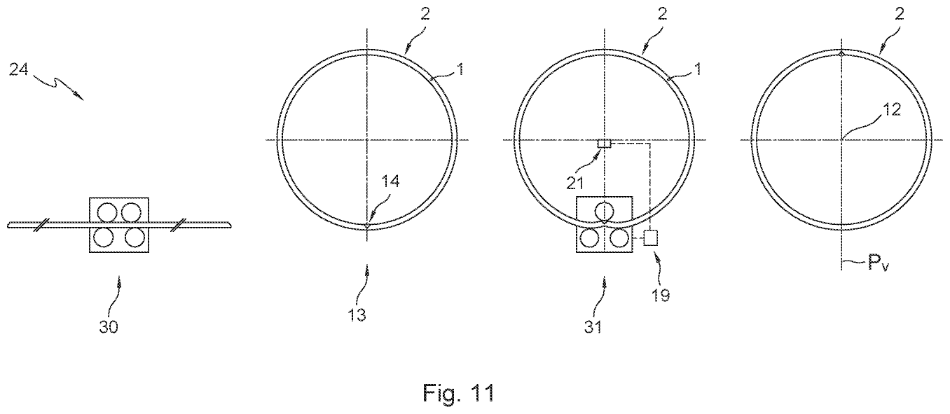

FIG. 11 schematically a press system for forming segments from strips according to the disclosure.

The embodiments shown in the drawings and described hereafter are shown only by way of example and should not be considered limiting the scope of the disclosure.

In the disclosure methods and systems are described for forming strips of metal into tubular or hollow truncated conical segments, which can be used for constructing multi segment hollow constructions by mounting two or more such segments on top of each other, as known in the art, for example for forming a foundation pile or tower of a wind turbine or of an off-shore construction. In the disclosure the strip of metal is shown and described as being rolled into a tubular segment having a circular cross section, or a truncated conical segment having circular cross section with a declining radius, from one longitudinal end of the segment towards the other. However, segments could be formed having a cross sectional profile different from circular, for example oblong, elliptical, or multi cornered.

In this description a cross sectional profile of a segment should be understood as the profile of the segment seen in a plane perpendicular to a longitudinal axis of the segment. This is the profile formed by pressing the strip into the shape of the segment. Metal strips should be understood as strips made of a metal deformable by a press, such as a roller press or a brake press. The strips can for example be made of steel or aluminum or a suitable metal alloy.

FIG. 1 shows a strip 1 for forming a segment 2 fed into a press 3, here shown as a roller press, especially a four roll roller press, as known in the art. Here the press 3 is shown, by way of example, having two upper rolls 4 and two lower rolls 5. The strip 1 is placed between the upper and lower rolls 4, 5, also referred to as inner and outer rolls 4, 5, such that when the upper rolls 4 are pressed down, relative to the lower rolls 5, the part of the strip between the rolls 4, 5 will be bent, as is for example shown in FIG. 1A for a three roll press. By moving the strip 1 through the press 3, the longitudinal ends 6, 7 of the strip 1 are forced to meet, as shown in FIG. 2, at least to such extend that a seam 8 is formed by and/or between said longitudinal ends 6, 7. Thus a segment 2 is formed having a substantially tubular shape.

In the drawings segments 2 are shown, formed from a single strip 1 each. The longitudinal length L of the strip 1 is in these examples equal to the circumference of the segment, according to the formula L=2πR, wherein R is the average radius of the cross section of the tubular segment 2. It is however also possible to form a segment out of two or more segment parts, wherein each segment part is pressed from a strip having a smaller length, such that each segment part forms part of the circumference of the segment, that is part of the outer wall 9 of the segment 2. For example two semicircular segment parts can be formed, welded together to form the segment 2, which will then have two seams 8. Similarly a segment 2 can be formed from three or more segment parts, welded together forming as many seams 8 as there are segment parts.

As can for example be seen in FIGS. 2 and 3, the longitudinal ends 6, 7 of the strip or strips may be machined, for example for forming a seam enhancing profile 10. In the embodiment shown the seam enhancing profile 10 is formed by chamfering the ends 6, 7, such that in the segment 2 formed a substantially V-shaped groove 11 is formed at the seam 8. In the embodiment shown the groove 11 is open towards a longitudinal axis 12 of the segment 2. After forming the segment 2, at least the seam 8, the ends 6, 7 may be tack welded together, in a known manner, in order to keep the ends 6, 7 close together while further handling the segment, at least until the seam 8 is properly seam welded, as will be described.

After forming the segment 2 in a segment forming station 30, the segment may be taken out of the press 3, as shown in FIG. 3, and then transferred to a welding station 13, as is shown for example in FIG. 11. However, welding could also be done while the segment 2 is still held by the press 3.

In FIG. 4 the segment 2 is shown in a welding station 13, with the seam 8 at the lower side, by way of example only. In the welding station 13 in a known manner a seam weld 14 is formed in and/or over the seam 8, using a welding tool 15, welding the two ends 6, 7 of the strip 1 together. This can be an automated or manual process or a combination of both.

As is shown in FIGS. 5 and 7 by way of example, the part 16 of the cross sectional profile P at and near the seam 8, at least at the seam weld 14 will be distorted, due to for example the heating and cooling of the part of the segment 2. In the drawings the distortion 17 may be exaggerated, in order to more clearly show the distortion 17. In the embodiment the distortion 17 is shown as an inward distortion 17. This is a distortion in the direction of the longitudinal axis 12 of the segment 2. Preferably the configuration of at least the seam enhancing profile 10 is chosen such that said distortion is inward. Such configuration is also referred to as “apple shaped”. It has been found that this can more easily be corrected than an outward facing distortion 17. However, an outward facing distortion can also occur, which is also referred to as “pear shaped”.

A distortion 17 in the cross section profile P of a segment 2 is undesirable, at least for connecting the segment 2 properly to an adjoining, further segment 2, for example when constructing for example a tower or pile, or a silo or tank. For example, the segments 2 will not fit properly one on top of the other, because of the distortion(s). Moreover such distortions can be detrimental to the strength of the segments and of a construction using such segments. Furthermore such distortions may be detrimental to the shape and appearance of the segments.

In a method of the disclosure therefore, as is shown in FIG. 6, the segment 2 can, after welding, be placed in a press system 18 of the disclosure, comprising at least a press 3, 20 and a control unit 19 for controlling the press. In the embodiments shown in for example FIGS. 6, 8 and 11 the press is a roller press, especially a three roll press 20, which is a different press from the press 3 as used for pre-rolling the strip 1 into the segment 2 having a substantially circular cross section, prior to welding, as for example shown in FIGS. 1 and 2. However, the press in the press system 18 can also be the same press 3.

As for example shown in FIG. 8 the press system 18 further comprises a measurement tool 21 for measuring at least part of a cross sectional profile P of the tubular or truncated conical segment 2, which measurement tool 21 is connected to the control unit 19 for feeding measurement data D into the control unit 19. The control unit 19 comprises at least an algorithm for controlling the press 3, 20, based on at least said measurement data D.

The measurement tool 21 preferably is a contact free measuring system, such as for example based on or comprising a laser measurement system 22. With the laser measurement system 22 an actual radius R_{A} can be measured at any location along an inner circumference of the segment extending around the measurement tool 21. In the embodiment shown in e.g. FIG. 6 the measurement tool 21 is located at or near the longitudinal axis 12 of the segment 2, facing straight up, such that the radius R_{A} can be measured directly between the longitudinal axis 12 and a measurement point or position T directly above the measurement tool 21, in a vertical plane Pᵥ extending through the longitudinal axis 12. Said plane Pᵥ hence lies perpendicular to the drawing. In FIG. 6 the measurement position T is at the most inner portion of the seam weld 14. By measuring the actual radius R_{A} at said measurement position or point T the cross sectional profile P can be assessed.

In the embodiment shown for example the segment can be rotated around the longitudinal axis 12, such that a sequence of measurement positions T can be obtained, for example in discrete steps or in a continuous process, wherein for each measurement position T the relative position and the actual radius R_{A} for that position is registered as data. Thus an even more accurate cross sectional profile P can be obtained of a relevant part 16 of the cross section, here an area around the seam 8, 14.

The measurement tool 21 can also be positioned differently, for example spaced apart from the longitudinal axis, as long as the position is known relative to e.g. the longitudinal axis 12, such that the actual radius R_{A} can be calculated from the measurement data obtained with said measurement tool 21. The measurement tool 21 can be positioned alternatively outside the segment 2, for example against or spaced apart from the outer surface 27.

The actual radius R_{A} in a position T can be compared to a desired radius R_{D} for that position. Based on such comparison then the press 3, 20 can be used for altering the cross sectional profile P, to bring it closer to the desired profile. It should be clear that in a tubular or conical segment 2 the desired radius R_{D} will or at least should be substantially the same for all positions T in a cross section. An aim of the method of the disclosure is to bring the R_{A} sufficiently close to the desired radius R_{D}. Data D of a measurement is hence fed into the control unit 19, where after the press 3, 20 is operated by the control unit 19 based on said data, adjusting the cross sectional profile P of the tubular segment 2, at least at the or each seam 8.

In embodiments the cross sectional profile P of a relevant part 16 of the segment 2 is measured using the measurement tool 21, wherein the measurement data D obtained with the measurement tool comprise at least location data D of a relevant part of the profile measured relative to the tool 21 and the distance between said part of the profile and the tool 21, i.e. the actual radius R_{A} or a measurement representative for said actual radius R_{A}.

In embodiments the control unit 19 can comprise a memory 23 comprising at least a predefined desired radius R_{D} of a segment 2 to be formed and wherein the control unit 19 and measurement tool 21 are designed for obtaining and processing measurement data D including location data of locations T at said segment 2 and radius data R_{A} at said locations. The control unit 19 further comprises an algorithm for comparing the radius R_{A} at said location T with the desired radius R_{D} and controlling the press 3, 20 based on said comparison. For segments 2 having a circular cross section or a segment part having a semi circular or part circular cross section a single desired radius R_{D} can be set in the control unit 19, between a set minimum radius Rₘᵢₙ and a set maximum radius Rₘₐₓ. After welding the actual radius R_{A} is measured at least at the seam 8, 14, which actual radius R_{A} is compared to the set desired radius R_{D}, where after the press 3 or 20 is operated by the control unit 19 for reducing any deviation between the actual radius R_{A} and the desired radius R_{D}. In embodiments the press 3 or 20 will force the relevant part of the cross sectional profile such that the actual radius will be forced between the set minimum radius Rₘᵢₙ and a set maximum radius Rₘₐₓ, as for example shown schematically in FIGS. 7 and 8

As discussed the metal strip can be rolled into the tubular shape or truncated conical shape using a roller press 3, which roller press 3 can be a press different from a press 20, such as for example a further roller press 20 or a brake press which is used for adjusting the cross sectional profile P after welding of the seam 8, 14. Using different presses 3, 20 before and after welding provides the advantage that the process of forming the tubular or truncated conical segments 2 can be performed substantially as a continuous or semi continuous process, wherein the segments can move along a production line 24 from the first press 3 to the second press 20, at least passing from a forming station 30 through a welding station 13 to a re-press station 31, without having to move a segment 2 back up the line 24, back to the first press 3. This is for example shown in FIG. 11. Moreover this allows for a selection of an optimal press as first press 3 and as second press 20. Alternatively the metal strip 1 can be rolled into the tubular shape or truncated conical shape using a roller press 3, which roller press 3 is the same press 3 as used for adjusting the cross sectional profile P, for example at the seam 8, 14 after welding.

In embodiments the control unit 19 comprises an algorithm in a computer system 25, designed for controlling the press 3, 20 for adjusting the cross sectional profile P, based on data D received from the measurement tool 21.

In an advantageous embodiment at least for adjusting the cross sectional profile P at the seam 8, 14 after welding a roller press 20 is used, having at least three rolls 4, 5, wherein the segment 2 is supported by two rolls 5 at an outer surface 26 of the segment 2, and at least a third roll 4 of said rolls 4, 5 is pushed against an inner surface 27 of the segment 2, towards the two rolls 5 at the outer surface 26. A force F for said pushing and/or a distance Dt of travel of the third roll 4 relative to the two rolls 5 at the outer surface 26 is controlled by the control unit 19 based on the measurement data D as discussed. For example for adjusting the profile P at the seam 8, 14 the two rolls at the outer surface 26 can be placed at opposite sides of the seam 8, 14 and the third roll 4 at or near the seam, at the inner surface 27.

It will be clear that with the same or a similar method and system also the cross sectional profile P at other positions than at the or a seam can be measured and assessed, for example for assessment of the full cross sectional profile of a segment, for example for assessment of the circularity of such cross section, whether this cross section falls entirely within a circle defined by a set outer maximum radius Rₘₐₓ and a circle defined by a set minimum radius Rₘᵢₙ.

As discussed the measurement tool 21 can be or can be part of a contact free measurement system, such as a laser measurement system, more specifically a laser measurement system suitable for distance measurement. Alternatively the measurement tool can comprise a camera, wherein an algorithm can be used for assessment of images taken of relevant parts of the cross sectional profile P, in order to assess an actual radius R_{A} at a location T. Alternatively or additionally a contact based measurement tool can be used, such as for example a digital measurement clock or a dial gauge measurement system, which can for example run against the inner surface 27 of the segment.

The control unit 19 preferably comprises the memory 23 comprising at least a predefined desired radius R_{D} of a segment 2, as schematically shown in FIGS. 2 and 9, to be formed and wherein the control unit 19 and measurement tool 21 are designed for obtaining and processing measurement data D including location data of locations T at said segment 2 and radius data at said locations T, wherein the control unit 19 further comprises an algorithm for comparing the actual radius R_{A} at said location T with the desired radius R_{D} and controlling the press 20 based on said comparison. Location data can for example comprise a rotation angle α of a location T_{α} at which a specific radius R_{A}(α) is measured, relative to a known location at the segment 2, especially at said cross sectional profile P, for example the or a seam 8, 14 or a marker provided on the segment 2, for example at an inner surface 26 thereof. For example in FIG. 6 the location T(α) is shown at the angle α relative to a vertical line Z through the seam 8, 14. Hence since the time the radius R_{A}(a) was measured in T(α), with a measurement tool 21 measuring the distance cq radius R_{A}(α) straight up in FIG. 6, the segment has been rotated over an angle α clockwise around the longitudinal axis 12. Hence the locations can be measured over an angle of 360 degrees, or any angle desired.

The control unit 19 preferably is designed for performing the steps of measuring the at least part of the cross sectional profile P of the tubular or truncated conical segment 2 and of controlling the relevant press 20, based on at least said measurement data D repetitively, during a pressing step of a segment. For example directly after welding of a seam a first measurement can be performed by the measurement tool, for example at the location T₁₄ of said seam 8, 14, during or after which measurement the press 20 is operated by the control unit 19 as discussed, to bring the actual radius R_{A} as measured closer to the desired, set radius R_{D} for that location. Then the radius R_{A} is again measured at said location T₁₄. If the radius R_{A} is still not close enough to the desired radius R_{D} again the press 20 will be operated in order to bring the radius R_{A} at the location T₁₄ closer to said desired radius R_{D}. These steps can be repeated as long as the deviation between R_{A} and R_{D} is still to large.

Preferably the press 20 is operated using a computer program product comprising a computer readable program for control of a pressing process for forming tubular or truncated conical metal segments 2, wherein the program is designed for receiving measurement data D pertaining to a cross sectional profile P of at least part of such segment 2 and controlling a press 20 for adjusting said profile P.

In this disclosure tubular segments 2 should be understood as meaning at least tubular elements having a substantially constant cross section over its longitudinal length Lₛ, as is for example shown in FIG. 10A. In this disclosure truncated conical segments 2 should be understood as meaning at least hollow elements having a substantially uniform, similar shaped but increasing or decreasing cross section over its longitudinal length Lₛ, as is for example shown in FIG. 10B. However segments according to the disclosure may also have different shapes, such as for example polygonal in cross section, i.e. perpendicular to the longitudinal axis 12, or for example barrel shaped, meaning in longitudinal direction starting from a first end having first an increasing sized cross section and subsequently towards the opposite end having a decreasing sized cross section.

With a press system and method according to the disclosure especially large segments can be formed for use as segments of a foundation pile or tower of a wind turbine or of an off-shore construction. Such segments 2 can for example be cylindrical or truncated conical having a maximum diameter D (2*R) of for example between 3 and 20 meters and a length Lₛ of for example between 2 and 6 meters. Such segments can for example be formed from steel strips 1 having a thickness S of between 1 and 10 cm, for example between 1 and 6 cm. For segments according to the disclosure deviations in a radius R_{A} compared to a set radius R_{D} may be acceptable up to for example a few millimeters, for example not more than 4 mm. Similarly deviations between radii of adjoining segments may not be more than for example 10 mm, for example not more than 4 mm.

In a method or press system according to the disclosure a known press 3, 20 can be used, for example as manufactured by Davi. Italy or Haeusler, Germany. Segments 2 for use in for example generator towers may also be referred to as cans.

The present disclosure is not limited to the embodiments shown and described here above, by way of example only. Many variants are possible within the scope of the disclosure as defined by the claims.

For example, the measurement tool can be or comprise a camera, with which images, such as optical images can be taken of a segment profile part 16, for example at or near a seam 8, from a longitudinal end of the segment, which image or images can then be compared to images stored of a segment as it is desired. Any deviations between these images can then be used for control of the press 3, 20 in order to bring the profile within tolerances. In stead of a roller press other types of presses can be used in the present invention, for forming and/or deforming a segment.

These and other variations are considered falling within the scope of the disclosure and of the invention as defined by the appending claims.

1. Method for forming tubular segments comprising:
pressing a metal strip or a series of metal strips into a tubular or truncated conical shape, such that opposite longitudinal ends of the strip or strips meet, forming at least one seam;
welding the seam, joining the meeting ends together;
after welding, measuring the cross sectional profile of at least part of the segment at least at and/or near said welded seam or seams;
feeding data of said measurement into a control unit;
after the data of said measurement is fed into the control unit, a press is operated by the control unit based on said data, adjusting the cross sectional profile of the segment, at least at the seam or at each seam; and
adjusting said cross sectional profile of the segment with a roller press.

2. Method according to claim 1, wherein the cross sectional profile of a relevant part of the segment is measured using a measurement tool, wherein the measurement data obtained with the measurement tool comprise at least location data of a relevant part of the profile measured relative to the tool and the distance between said part of the profile and the tool.

3. Method according to claim 1, wherein the metal strip is rolled or set into a segment having, at least at one end of the segment, a circular or semicircular cross section for which a desired radius is set in the control unit between a set minimum radius and a set maximum radius, wherein after welding the actual radius is measured at least at the seam, which actual radius is compared to the set desired radius, where after the press is operated by the control unit for reducing any deviation between the actual radius and the desired radius.

4. Method according to claim 3, wherein the press is operated by the control unit, bringing the actual radius between the set minimum radius and the set maximum radius.

5. Method according to claim 1, wherein the metal strip is rolled into the tubular shape or truncated conical shape using a roller press, which roller press is a press different from the roller press used for adjusting the cross sectional profile after welding.

6. Method according to claim 1, wherein the metal strip is rolled into the tubular shape or truncated conical shape using a roller press, which roller press is the same press as used for adjusting the cross sectional profile at the seam after welding.

7. Method according to claim 1, wherein the control unit comprises an algorithm controlling the press for adjusting the cross sectional profile at least at the seam.

8. Method according to claim 1, wherein at least for adjusting the cross sectional profile at the seam after welding a roller press is used, having at least three rolls, wherein the segment is supported by two rolls at an outer surface of the segment, at opposite sides of the seam, and at least a third roll of said rolls is pushed against an inner surface of the segment, at or near the seam, towards the two rolls at the outer surface, wherein a force for said pushing and/or a distance of travel of the third roll relative to the two rolls at the outer surface is controlled by the control unit based on the measurement data.

9. Method according to claim 1, wherein the cross sectional profile is measured using at least a laser system.

10. Method according to claim 1, wherein the segments are formed as segments of a foundation pile or tower of a wind turbine or of an off-shore construction.

11. Press system for forming a tubular or truncated conical metal segment, comprising:
at least a press and a control unit for controlling the press, wherein the system further comprises a measurement tool for measuring at least part of a cross sectional profile of the tubular or truncated conical segment, which measurement tool is connected to the control unit for feeding measurement data into the control unit, and wherein the control unit comprises at least an algorithm for controlling the press, based on at least said measurement data, wherein the press is a roller press.

12. Press system according to claim 11, wherein the measurement tool comprises a contact free measuring system.

13. Press system according to claim 11, wherein the measurement tool comprises a laser measurement system.

14. Press system according to claim 11, wherein the control unit comprises a memory comprising at least a predefined desired radius of a segment to be formed and wherein the control unit and measurement tool are designed for obtaining and processing measurement data including location data of locations at said segment and radius data at said locations, wherein the control unit further comprises an algorithm for comparing the radius at said location with the desired radius and controlling the press based on said comparison.

15. Press system according to claim 11, wherein the press system comprises at least a first press for pre-pressing a segment, a welding station for welding at least one seam in said segment and a second press for re-pressing the formed segment after having undergone a welding process in said welding station.

16. Press system according to claim 11, wherein the control unit comprises an algorithm for performing the steps of measuring the at least part of a cross sectional profile of the tubular or truncated conical segment and of controlling the press, based on at least said measurement data repetitively, during a pressing step of a segment.

17. Press system according to claim 16, wherein the control unit is designed for using the measurement data of pressing steps for assessment of the control of the press during a subsequent pressing step.

18. Computer program product comprising:
a computer readable program for control of a pressing process for forming tubular or truncated conical metal segments, wherein the program is designed for receiving measurement data pertaining to a cross sectional profile of at least part of such segment and controlling a roller press for adjusting said profile.

19. Computer program product according to claim 18, wherein the program is designed for controlling a relative position of rolls of a roller press.

20. Method according to claim 1, wherein at least two presses are used, one for prepressing or bringing the strip roughly into the desired tubular or truncated shape, and a second press for adjusting the cross sectional profile of the tubular segment after welding.

21. Method according to claim 16, wherein at least one part of the cross sectional profile of a segment is adjusted in a series of two or more adjusting steps, with at least a measurement step in between the adjusting steps, such that the relevant radius at the location is brought closer to the desired radius in consecutive steps.

22. Method according to claim 1, wherein the segment is assembled of at least two strips of metal.

23. Press system according to claim 11, wherein the system comprises at least a first press for pre-pressing a segment, a welding station for welding at least one seam in said segment and a second press for re-pressing the formed segment after having undergone a welding process in said welding station.

24. Press system according to claim 23, wherein the first and second press are different presses, stationed near a beginning and near an end of a segment processing line, wherein a welding station is located in between the two presses.

25. Press system according to claim 23, wherein the first press has at least four rolls and the second press has at least three rolls, wherein preferably the first press has four press rolls and the second press has three press rolls.
